(19) United States
(12) Patent Application Publication
(10) Pub. No.: US 2017/0089560 A1
(43) Pub. Date: Mar. 30, 2017

(54) OUTDOOR LIGHT

(71) Applicants: XIAOFENG ZOU, SHENZHEN (CN); YEREN LIU, SHENZHEN (CN); QIANG LI, SHENZHEN (CN); ZHIJIN LIN, SHENZHEN (CN); KAIFA MO, SHENZHEN (CN)

(72) Inventors: XIAOFENG ZOU, SHENZHEN (CN); YEREN LIU, SHENZHEN (CN); QIANG LI, SHENZHEN (CN); ZHIJIN LIN, SHENZHEN (CN); KAIFA MO, SHENZHEN (CN)

(21) Appl. No.: 14/986,969

(22) Filed: Jan. 4, 2016

(30) Foreign Application Priority Data
Sep. 30, 2015 (CN) 201520771626.2

(51) Int. Cl. F21V 29/70; F21V 7/04; F21V 15/01; F21V 23/04; F21V 19/00; F21V 1/22; F21V 31/00; F21V 1/00; F21V 23/02

(52) U.S. Cl. CPC F21V 29/70; F21V 1/00; F21V 7/04; F21V 15/01; F21V 23/02; F21V 19/0015; F21V 1/22; F21V 31/005; F21V 23/0442; F21Y 2115/10

(57) ABSTRACT

An outdoor light includes: a lampshade, a printed circuit board (PCB) for supporting an light emitting diode light source, a supporting board, a power supply assembly, and a housing, wherein the lampshade is connected to the housing, the PCB is mounted on the supporting board, the supporting board and the housing are integrally formed, the supporting board has a mounting face configured to face the lampshade for installing the PCB, the PCB is firmly attached to the mounting face of the supporting board, the power supply assembly is located in the housing, the PCB is electrically connected to the power supply assembly.

### FIELD OF THE INVENTION

The present disclosure relates to lamps, and more particularly relates to an outdoor light.

### BACKGROUND OF THE INVENTION

The technology of light emitting diode (LED) has rapidly developed in recent years from indicators to illumination applications. With the features of long-term reliability, environment friendliness and low power consumption, the LED is viewed as a promising alternative for future lighting products.

The reliability and the service life of the LED lighting largely depends on the heat dissipation capability thereof, therefore the improvement of the thermal performance of LED lamps is the key factor to improve the overall performance of the LED lamps. Nowadays, the LED lamp has been wildly applied to outdoor lightings. A problem with current outdoor LED light is that, since the LEDs in the outdoor light are suspended and are not in contact with the housing directly, the housing with a restricted heat dissipating area is unable to remove heat from the LEDs effectively.

Therefore, there is room for improvement within the art.

### SUMMARY OF THE INVENTION

The present disclosure is directed to an outdoor light with a better heat dissipation performance.

An outdoor light includes: a lampshade, a printed circuit board (PCB) for supporting an light emitting diode light source, a supporting board, a power supply assembly, and a housing, wherein the lampshade is connected to the housing, the PCB is mounted on the supporting board, the supporting board has a mounting face configured to face the lampshade for installing the PCB, the PCB is firmly attached to the mounting face of the supporting board, the power supply assembly is located in the housing, the PCB is electrically connected to the power supply assembly.

In one embodiment, the supporting board and the housing are integrally formed.

In one embodiment, the outdoor light further includes a reflector located on the supporting board, wherein the reflector defines a hole to accommodate the PCB; the reflector has a tapered shape, the supporting board is shaped to match with the reflector.

In one embodiment, the housing is made of metal.

In one embodiment, the supporting board is coated with a layer of thermal grease on the mounting face thereof.

In one embodiment, the lampshade is shaped as a triangular prism, one side of the lampshade defines an opening, the lampshade is connected to the housing by rims of the opening, each surface of the lampshade is provided with a strip-like protrusion for enhancing light refraction.

In one embodiment, the lampshade is made of transparent polycarbonate (PC).

In one embodiment, the lampshade and the housing are provided with a first sealing ring therebetween.

In one embodiment, the housing comprises a first housing and a second housing connected to the first housing, the first housing is connected to the lampshade, the first housing and the second housing are provided with a second sealing ring therebetween, the power supply assembly is located in a cavity formed by the second housing.

In one embodiment, the second housing defines at least one wiring pass-though hole.

In one embodiment, the outdoor light further includes a sensor located in the housing, wherein the sensor is selected from the group consisting of a motion sensor, a temperature sensor, a light sensor, and a voltage sensor.

In the forgoing outdoor light, since the PCB is mounted on the supporting board and is firmly attached to the supporting board to form a surface contact, the heat produced by the LED light source can be conducted to the housing through the supporting board, then the heat can be dissipated by the housing, thus greatly enhancing the heat dissipation performance of the outdoor light.

These and other objects, advantages, purposes and features will become apparent upon review of the following specification in conjunction with the drawings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an exploded view of an outdoor light according to an embodiment;

FIG. 2 is an assembly view of the outdoor light of FIG. 1;

FIG. 3 is a front view of the reflector of FIG. 1;

FIG. 4 is a left-side view of the reflector of FIG. 1;

FIG. 5 is a perspective view of the first housing of FIG. 1.

### DETAILED DESCRIPTION OF THE EMBODIMENTS

Reference will now be made to the drawings to describe, in detail, embodiments of the present outdoor light. It should be noted that references to “an” or “one” embodiment in this disclosure are not necessarily to the same embodiment, and such references mean at least one.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,”“above,” “below” and words of similar import, when used in this application, shall refer to this application as a whole and not to any particular portions of this application. When the claims use the word ^{or} in reference to a list of two or more items, that word covers all of the following interpretations of the word: any of the items in the list, all of the items in the list and any combination of the items in the list.

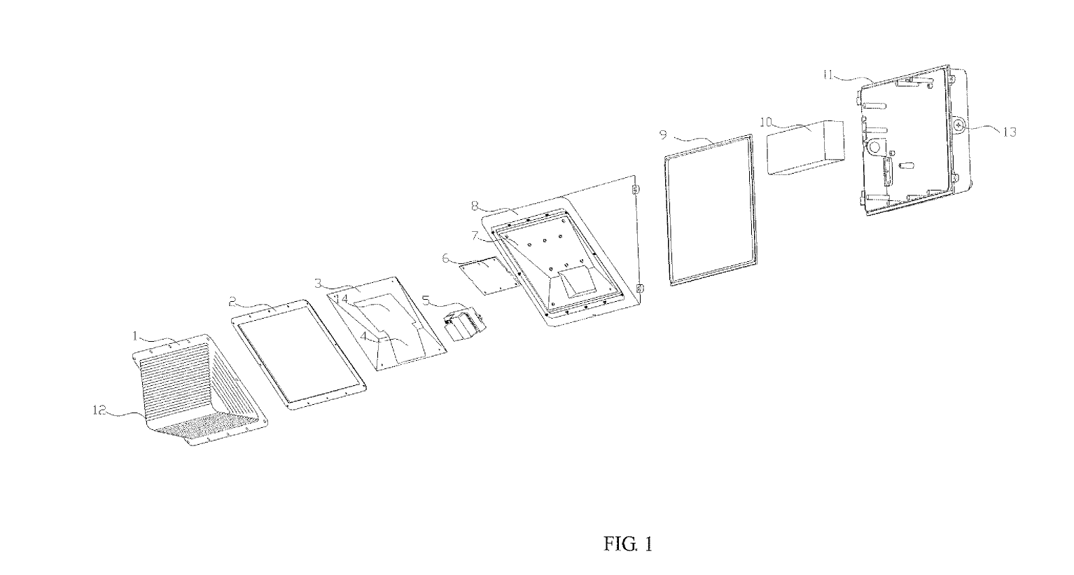

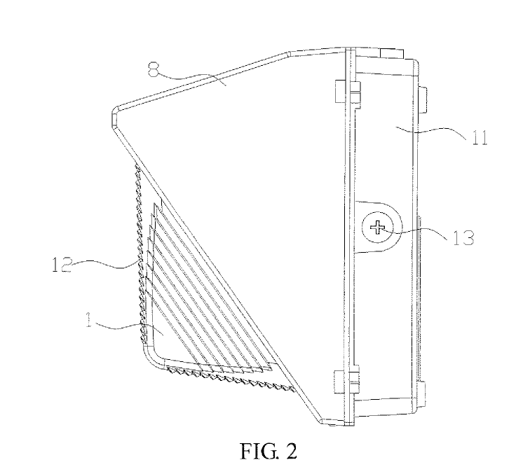

Referring to FIG. 1 and FIG. 2, an embodiment of an outdoor light includes a lampshade 1, a printed circuit board (PCB) 6 for supporting an LED light source, a supporting board 7, a power supply assembly 10, and a housing. The lampshade 1 is connected to the housing. The PCB 6 is mounted on the supporting board 7. The supporting board 7 and the housing are integrally formed. The power supply assembly 10 is located in the housing. The PCB 6 is electrically connected to the power supply assembly 10. The housing is made of metal.

The lampshade 1 is shaped as a triangular prism, and one side of the triangular prism shaped lampshade 1 defines an opening. The lampshade 1 is connected to the housing by rims of the opening. Each surface of the lampshade 1 is provided with a strip-like protrusion 12 for enhancing light refraction, while in the conventional lampshade, only the side surfaces rather than the bottom surface of the triangular prism are provided with the strip-like protrusion. Since every surfaces of the lampshade 1 are provided with strip-like protrusions 12, the luminous flux of the lampshade 1 is up to 85% of the total flux in an angle range between the vertical direction and the horizontal direction, while the luminous flux of the conventional lampshade can only reach 70% to 80% of the total flux. The lampshade 1 is made of transparent polycarbonate (PC). Comparing to glass employed by the conventional lampshade, the PC used in the present lampshade 1 can not only reduce the weight, but can also prevent the lampshade 1 from being broken due to its physical properties.

The outdoor lights installed outdoors are subject to wind and rain, thus a good waterproof performance is always required. In the illustrated embodiment, a first sealing ring 2 is provided between the lampshade 1 and the housing. The first sealing ring 2 is made of rubber embedded with metal braid. The housing includes a first housing 8 and a second housing 11 connected to the first housing 8. The first housing 8 is connected to the lampshade 1 and defines a groove 15 (see FIG. 15) to receive the first sealing ring 2 on an outer margin thereof. A second sealing ring 9 is provided between the first housing 8 and the second housing 11. The power supply assembly 10 is located in a cavity formed by the second housing 11. In the conventional outdoor lights, after the glass lampshade and the housing are assembled together, waterproof glue is coated on the connection between the lampshade and the housing, which is complex and time-consuming. However, the present outdoor light employs the first sealing ring 2 and the second sealing ring 9 as the waterproof element, thus the assembly is simple and a better waterproof performance can be obtained. The second housing defines at least one wiring pass-though hole 13 to allow the cable to pass through.

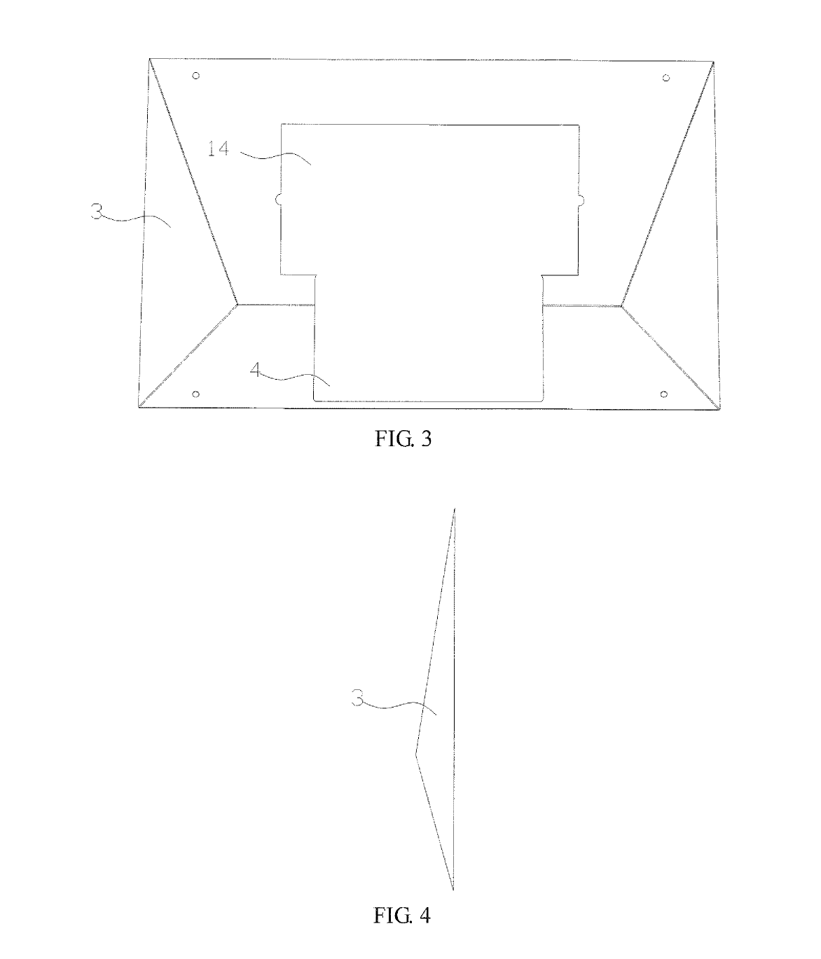

The outdoor light further includes a reflector 3 located on the supporting board 7. Referring to FIG. 3 and FIG. 4, the reflector 3 has a tapered shape with a gradually decreasing width from the edge toward the middle portion. The reflector 3 defines a substantially rectangular hole 14 to accommodate the PCB 6.

The outdoor light further includes a sensor 5 located in the housing, the sensor 5 can be a motion sensor, a temperature sensor, a light sensor, or a voltage sensor. The reflector 3 defines a mounting hole 4 to accommodate the sensor 5. In the illustrated embodiment, the mounting hole 4 is in fluid communication with the rectangular hole 14.

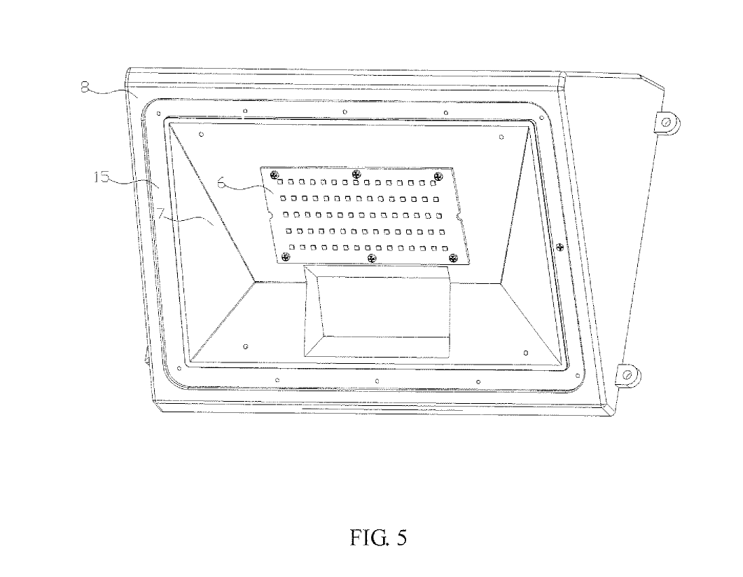

Referring to FIG. 5, the supporting board 7 has a shape similar to that of the reflector 3 and has a mounting face for installing the PCB 6, the mounting face is configured to face the lampshade 1. The PCB 6 is firmly attached to the mounting face of the supporting board 7 by screws. Since the PCB 6 is mounted on the supporting board 7 and is firmly attached to the supporting board 7 to form a surface contact, the heat produced by the LED light source can be conducted to the housing through the supporting board 7, then the heat can be dissipated by the housing, thus greatly enhancing the heat dissipation performance of the outdoor light. In one embodiment, the supporting board 7 is coated with a layer of thermal grease on the mounting face for the PCB 6 to help heat dissipation, thus further enhancing the heat dissipation between the PCB 6 and the supporting board 7.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. An outdoor light, comprising a lampshade, a printed circuit board (PCB) for supporting an light emitting diode (LED) light source, a supporting board, a power supply assembly, and a housing, wherein the lampshade is connected to the housing, the PCB is mounted on the supporting board, the supporting board has a mounting face configured to face the lampshade for installing the PCB, the PCB is firmly attached to the mounting face of the supporting board, the power supply assembly is located in the housing, the PCB is electrically connected to the power supply assembly.

2. The outdoor light according to claim 1, wherein the supporting board and the housing are integrally formed.

3. The outdoor light according to claim 1, further comprising a reflector located on the supporting board, wherein the reflector defines a hole to accommodate the PCB; the reflector has a tapered shape, the supporting board is shaped to match with the reflector.

4. The outdoor light according to claim 1, wherein the housing is made of metal.

5. The outdoor light according to claim 1, wherein the supporting board is coated with a layer of thermal grease on the mounting face thereof.

6. The outdoor light according to claim 1, wherein the lampshade is shaped as a triangular prism, one side of the lampshade defines an opening, the lampshade is connected to the housing by rims of the opening, each surface of the lampshade is provided with a strip-like protrusion for enhancing light refraction.

7. The outdoor light according to claim 1, wherein the lampshade is made of transparent polycarbonate (PC).

8. The outdoor light according to claim 1, wherein the lampshade and the housing are provided with a first sealing ring therebetween.

9. The outdoor light according to claim 1, wherein the housing comprises a first housing and a second housing connected to the first housing, the first housing is connected to the lampshade, the first housing and the second housing are provided with a second sealing ring therebetween, the power supply assembly is located in a cavity formed by the second housing.

10. The outdoor light according to claim 9, wherein the second housing defines at least one wiring pass-though hole.

11. The outdoor light according to claim 1, further comprising a sensor located in the housing to monitor, wherein the sensor is selected from the group consisting of a motion sensor, a temperature sensor, a light sensor, and a voltage sensor.
